(19) United States
(12) Patent Application Publication
(10) Pub. No.: US 2014/0014445 A1
(43) Pub. Date: Jan. 16, 2014

(54) APPARATUS AND METHODS FOR SECURING TRAILER TONGUES AND TRAILER WHEELS

(71) Applicant: Kris Talynn, Stansbury, UT (US)

(72) Inventor: Kris Talynn, Stansbury, UT (US)

(21) Appl. No.: 13/937,555

(22) Filed: Jul. 9, 2013

Related U.S. Application Data
(60) Provisional application No. 61/669,895, filed on Jul. 10, 2012.

(51) Int. Cl. B60T 3/00

(52) U.S. Cl. CPC B60T 3/00
USPC 188/32; 29/428

(57) ABSTRACT

Tongue block assemblies include a tongue block and detachable wheel chocks. According to one example, a tongue block assembly includes a tongue block with a plurality of wheel chock attachment structures, and a plurality of wheel chocks with corresponding tongue block attachment structures. Each tongue block attachment structure of the wheel chocks may be coupled with a wheel chock attachment structure of the tongue block. In use, at least one wheel chock may be decoupled from a tongue block. The tongue block may be positioned to receive at least a portion of a trailer tongue, and the one or more wheel chocks may be positioned adjacent to a trailer wheel. Other aspects, embodiments, and features are also included.

### CLAIM OF PRIORITY UNDER 35 U.S.C.§119

The present Application for Patent claims priority to Provisional Application No. 61/669,895 entitled “Apparatus for Securing Trailer Tongues and Wheels, Methods of Making Such Apparatus, and Methods of Use” filed Jul. 10, 2012, the entire disclosure of which is hereby expressly incorporated by reference herein.

### TECHNICAL FIELD

The following relates generally to trailers, and more specifically to devices and methods for supporting a trailer tongue and restraining a trailer wheel from movement.

### BACKGROUND

Generally, a trailer includes a tongue adapted to be hitched to a vehicle, which vehicle can move the trailer as desired. When the trailer is unhitched from the vehicle, the tongue is often supported in an elevated position, such that the trailer is retained in a level position. Additionally, the trailer's wheels are often braced with a device commonly referred to as a chock. At least one chock is typically positioned against the wheel to keep the trailer from moving.

A user typically keeps both a block suitable to support the elevated tongue, as well as separate chocks for the wheels.

### BRIEF SUMMARY OF SOME EXAMPLES

Various features and aspects of the present disclosure are adapted to provide a trailer tongue block adapted to be coupled with a plurality of wheel chocks to form a unitary and portable assembly.

According to at least one aspect of the disclosure, tongue block assemblies are disclosed. In one or more examples, such tongue block assemblies may include a tongue block including a plurality of wheel chock attachment structures. A plurality of wheel chocks are also included. Each wheel chock may include at least one tongue block attachment structure. Each tongue block attachment structure may be detachably coupled with a wheel chock attachment structure of the tongue block.

Further aspects of the present disclosure provide methods of making a tongue block assembly. According to one or more examples, such methods may include formation of a tongue block including a plurality of wheel chock attachment structures. A plurality of wheel chocks may also be formed, where each wheel chock includes at least one tongue block attachment structure. The one or more tongue block attachment structures of each wheel chock may be coupled to a respective wheel chock attachment structure of the tongue block

Still additional aspects of the present disclosure provide methods of using a tongue block assembly. According to at least one example, such methods may include decoupling at least one wheel chock from a tongue block. The tongue block may be positioned to receive at least a portion of a trailer tongue. The one or more decoupled wheel chocks may be positioned to be adjacent to a trailer wheel.

Other aspects, features, and embodiments associated with the present disclosure will become apparent to those of ordinary skill in the art upon reviewing the following description in conjunction with the accompanying figures.

### DRAWINGS

FIG. 1 is an isometric view of tongue block assembly according to at least one example.

FIG. 2 is a side elevation view of the tongue block of FIG. 1 according to at least one example.

FIG. 3 is a side elevation view of the wheel chocks of FIG. 1 are shown according to at least one example.

FIG. 4 is a side elevation view of three examples of a trailer with different tongues positioned on an example of a tongue block of the present disclosure and with examples of wheel chocks of the present disclosure behind a wheel.

FIG. 5 is a flow diagram illustrating at least one example of a method of making a tongue block assembly.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details.

The illustrations presented herein are, in some instances, not actual views of any particular tongue block, wheel chocks or tongue block assembly, but are merely idealized representations which are employed to describe aspects of the present disclosure. Additionally, elements common between figures may retain the same numerical designation.

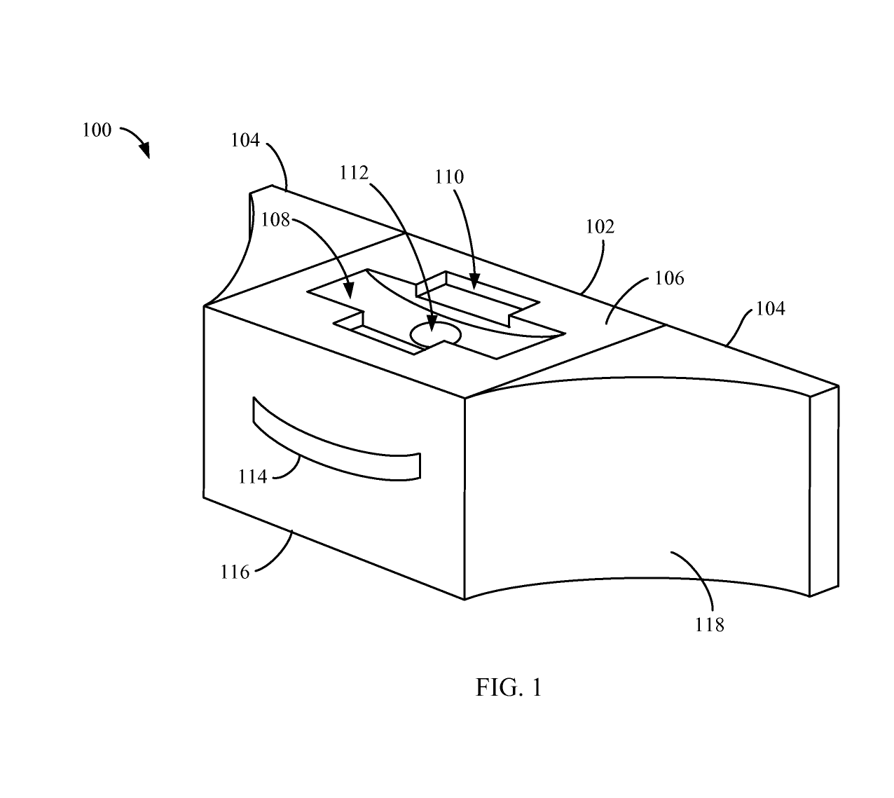

Various examples of the present disclosure include a tongue block including a plurality of wheel chocks releasably or detachably coupled thereto. Referring to FIG. 1, an isometric view of a tongue block assembly 100 is depicted according to at least one embodiment. The assembly 100 includes a tongue block 102 coupled with a plurality of wheel chocks 104. The tongue block 102 includes a surface 106 on which a portion of a trailer tongue (e.g., a wheel, foot, or post of a trailer tongue) may be supported.

The surface 106 may include one or more depressions or openings adapted to at least partially secure a portion of the trailer tongue on the surface 106. For example, the surface 106 may include an arcuate depression 108, a substantially rectangular or square depression 110, and/or a substantially round hole or depression 112. The arcuate depression 108 may be large enough to receive a typical wheel of a trailer tongue, such that the wheel can rest in the depression 108 when the trailer is disconnected from a vehicle. The rectangular or square depression 110 may be sized and shaped to receive a foot of a trailer tongue, such that the foot can rest in the depressed area 110 when the trailer is disconnected from a vehicle. The round or circular depression 112 may be sized and shaped to receive a post of a trailer tongue, such that the post can be positioned at least partially within the circular depression 112. In at least some examples, the circular depression 112 may be deep enough that the post can rest therein at a depth of about 2 inches, although the actually depth may vary according to various embodiments. In some examples, the tongue block 102 may include a handle 114 to facilitate portability of the tongue block 102, as well as the assembly 100.

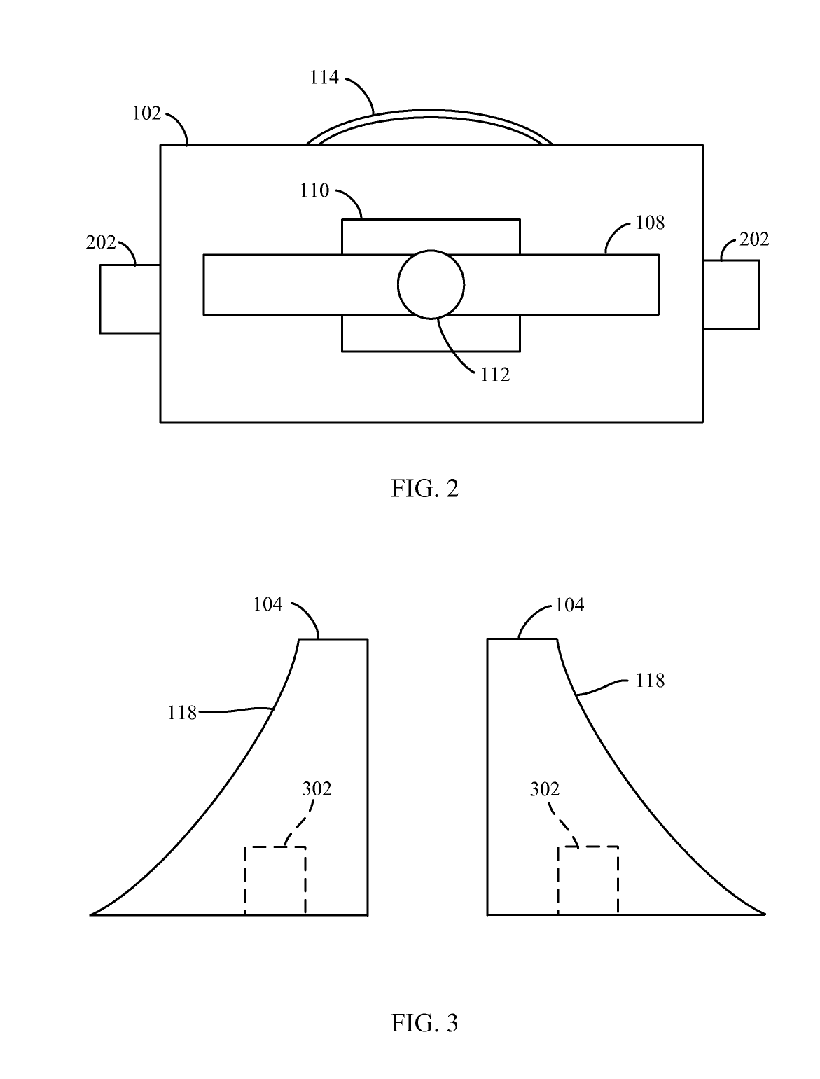

FIG. 2 is a side elevation view of the tongue block 102. As shown, the tongue block 102 further includes chock attachment structures 202. In general, each chock attachment structure 202 can include a structure adapted to facilitate coupling or attaching one or more chocks 104. In the example depicted in FIG. 2, the chock attachment structures 202 are configured as outwardly extending protrusions. Such protrusions may include threads or some other locking mechanism adapted to be received in and affixed to a corresponding cavity or aperture in a chock 104. In other examples, the chock attachment structures 202 can be configured as at least one cavity or aperture in the tongue block 102 adapted to receive a corresponding protrusion formed in a chock 104. In other examples, the chock attachment structures 202 may include one or more fasteners, such as snaps, hook and loop (e.g., VELCRO), magnets, screws, etc. A person of ordinary skill in the art will be able to identify various different, yet suitable, configurations for the chock attachment structures 202.

Referring to FIG. 1 again, the tongue block 102 can be formed of a material sufficiently strong enough to support the weight of a trailer tongue. By way of example and not limitation, the tongue block 102 may be formed from a polymer, a metal or metal alloy, a rubber, wood, or other suitable material, as well as combinations thereof In at least some examples, a surface 116 opposite from the surface 106 may include a slip-resistant structure. The slip-resistant structure may include a slip-resistant material or surface, such as a rubber surface and/or surface texture adapted to reduce or eliminate slipping of the tongue block 102 when positioned on the ground.

The wheel chocks 104 can be generally shaped and configured in a wedge-like shape, having a surface 118 adapted to be positioned in contact with a wheel to keep the wheel from rolling. Turning to FIG. 3, a side elevation view of the wheel chocks 104 is shown according to at least one example. Each of the wheel chocks 104 includes a tongue block attachment structure 302. In general, the tongue block attachment structures 302 can include a structure adapted to facilitate coupling with or attachment to the chock attachment structures 202 of the tongue block 102 (see FIG. 2). In the embodiment depicted by FIG. 3, the tongue block attachment structures 302 are configured as inwardly extending cavities or apertures. Such cavities or apertures may include threads or some other locking mechanism adapted to receive and be coupled to a corresponding protrusion in the tongue block 102. In other examples, the tongue block attachment structures 302 can be configured as at least one protrusion in the wheel chock 104 adapted to be received in a corresponding cavity or aperture formed in a tongue block 102. In other examples, the tongue block attachment structures 302 may include one or more fasteners, such as snaps, hook and loop (e.g., Velcro), etc. A person of ordinary skill in the art will be able to identify a plurality of different, yet suitable, configurations for the tongue block attachment structures 302.

The wheel chocks 104 may also be made from any of a plurality of materials. By way of example and not limitation, the wheel chocks 104 may be a polymer, metal or metal alloy, rubber, wood, or other suitable material, as well as combinations thereof. The wheel chocks 104 may also include a slip-resistant material or surface on a bottom surface thereof, such as a rubber surface and/or surface texture adapted to reduce or eliminate slipping of the wheel chocks 104 when positioned on the ground.

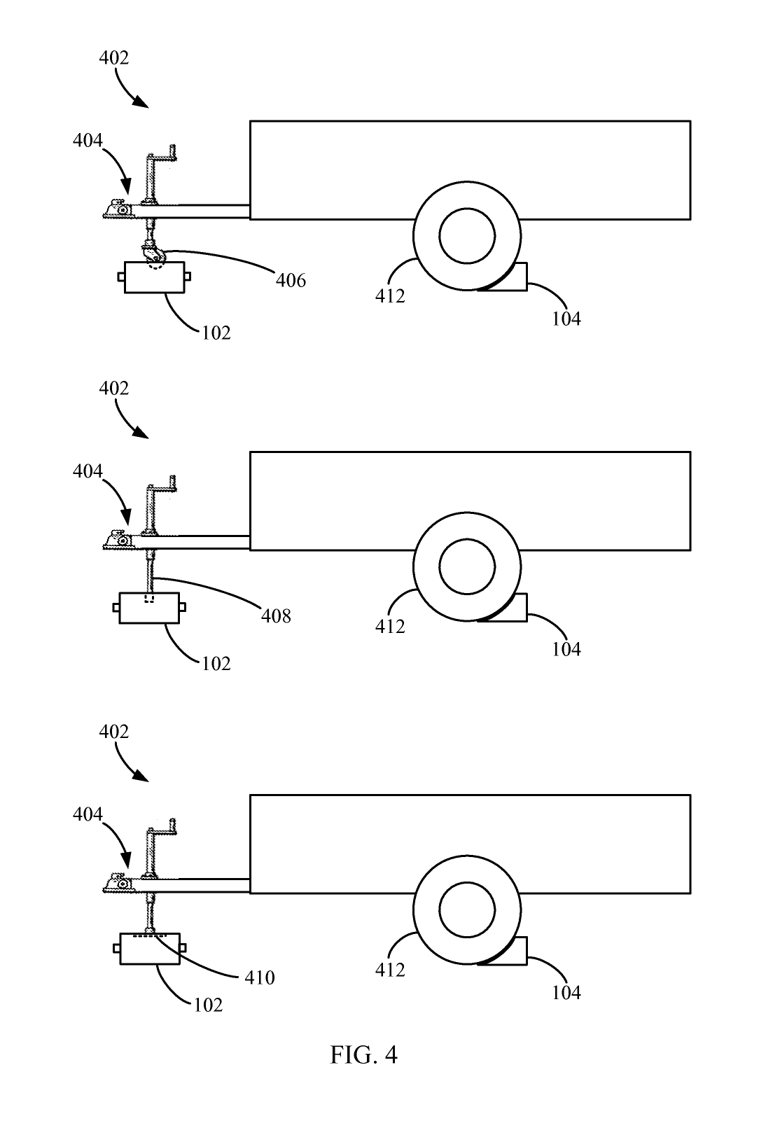

In operation, the wheel chocks 104 can be decoupled or detached from the tongue block 102. For example, a user can decouple or detach the chock attachment structures 202 of the tongue block 102 from the tongue block attachment structures 302 of each respective wheel chock 104. Referring to FIG. 4, a side elevation view is illustrated of three different examples of a trailer 402. As shown in FIG. 4, the tongue block 102 can be positioned under a tongue 404 of the trailer 402. In the top example, a wheel 406 associated with the trailer tongue 404 can be disposed in, and at least partially retained in the arcuate depression 108 (see FIG. 1) of the tongue block 102. In the middle example, a post 408 associated with the trailer tongue 404 can be disposed within a circular depression 112 (see FIG. 1) of the tongue block 102. In the bottom example, a foot 410 associated with the trailer tongue 404 can be disposed within the rectangular or square depression 110 (see FIG. 1) of the tongue block 102. In each of the three examples, the decoupled wheel chocks 104 are disposed adjacent a wheel 412 of the trailer 402.

When a user is finished with the tongue block 102 and the wheel chocks 104, the wheel chocks 104 can be coupled or reattached to the tongue block 102. For example, a user can couple or attach the tongue block attachment structures 302 of each wheel chock 104 to a respective chock attachment structure 202 of the tongue block 102. With the wheel chocks 104 coupled to the tongue block 102, the user can store or carry the tongue block assembly 100 as desired.

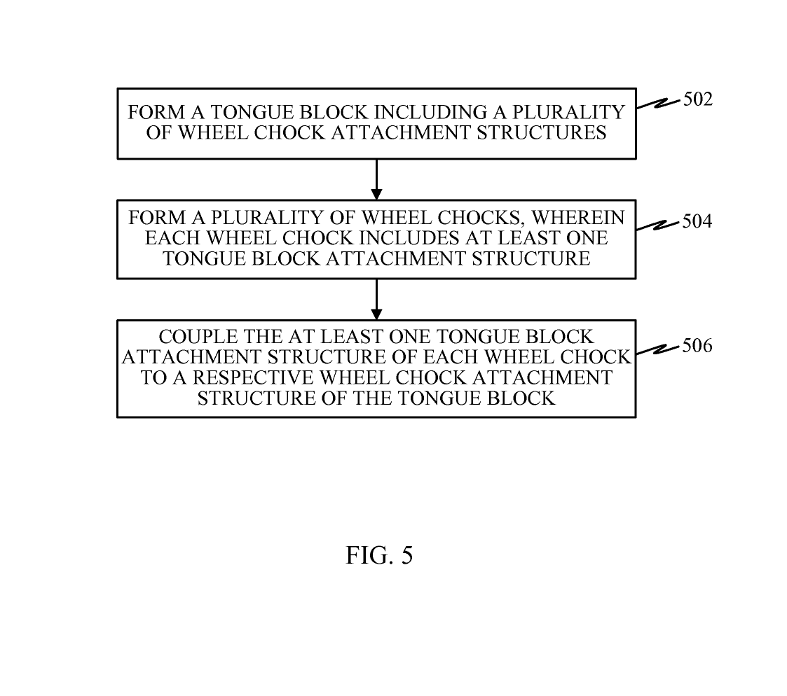

Additional aspects of the present disclosure relate to methods of making a tongue block assembly, such as the tongue block assembly 100 in FIG. 1. FIG. 5 is a flow diagram illustrating at least one example of such methods. With reference to FIGS. 1, 2 and 5, a tongue block 102 may be formed at step 502. The tongue block 102 can be formed to include a plurality of wheel chock attachment structures 202. In some examples, the chock attachment structures 202 may be formed as outwardly extending protrusions. Such protrusions may include threads or some other locking mechanism adapted to be received in and affixed to a corresponding cavity or aperture in a chock 104. In other examples, the chock attachment structures 202 can be formed as at least one cavity or aperture in the tongue block 102 adapted to receive a corresponding protrusion formed in a chock 104. In other examples, the chock attachment structures 202 may be formed to include one or more fasteners, such as snaps, hook and loop (e.g., Velcro), magnets, etc. A person of ordinary skill in the art will be able to identify various different, yet suitable, configurations for the chock attachment structures 202.

The wheel chock attachment structures 202 may, in some examples, be formed integral to the tongue block 102, such as by machining, casting, and/or molding. In other examples, the wheel chock attachment structures 202 may be formed as separate components that are attached (e.g., welded, glued, fastened) to the tongue block 102.

Forming the tongue block 102 may also include forming a depression in a surface 106 of the tongue block 102. According to various examples, the depression may be formed as at least one of an arcuate depression 108, a rectangular depression, a square depression 110, and/or a circular depression 112.

The tongue block 102 can be formed of any of various materials using conventional manufacturing techniques, such as molding, casting, and/or machining. By way of example and not limitation, the tongue block 102 may be formed from a polymer, a metal or metal alloy, a rubber, wood, or other suitable material, as well as combinations thereof. In some examples, the tongue block 102 may be formed to include a slip-resistant structure disposed on at least one surface thereof, such as on a surface 116 opposite from the surface 106 in which the depression is formed. The slip-resistant structure may be formed by disposing a slip-resistant material or surface on the surface 116 of the tongue block 102. Such a slip-resistant material or surface may include a rubber surface and/or surface texture adapted to reduce or eliminate slipping of the tongue block 102 when positioned on the ground.

At step 504, a plurality of wheel chocks 104 are formed. Each wheel chock 104 can be formed to include at least one tongue block attachment structure 302.

In general, the tongue block attachment structures 302 can be formed to include a structure adapted to facilitate coupling with or attachment to the chock attachment structures 202 of the tongue block 102. In some examples, the tongue block attachment structures 302 may be formed as inwardly extending cavities or apertures. Such cavities or apertures may include threads or some other locking mechanism adapted to receive and be coupled to a corresponding protrusion in the tongue block 102. In other examples, the tongue block attachment structures 302 can be formed as at least one protrusion in the wheel chock 104 adapted to be received in a corresponding cavity or aperture formed in a tongue block 102. In other examples, the tongue block attachment structures 302 may include one or more fasteners, such as snaps, hook and loop (e.g., Velcro), etc. A person of ordinary skill in the art will be able to identify a plurality of different, yet suitable, configurations for the tongue block attachment structures 302.

The tongue block attachment structures 302 may, in some examples, be formed integral to a respective wheel chock 104, such as by machining, casting, and/or molding. In other examples, the tongue block attachment structures 302 may be formed as separate components that are attached (e.g., welded, glued, fastened) to the wheel chock 104.

The wheel chocks 104 may also be formed of any of various materials using conventional manufacturing techniques, such as molding, casting, and/or machining. By way of example and not limitation, the wheel chocks 104 may be formed from a polymer, metal or metal alloy, rubber, wood, or other suitable material, as well as combinations thereof In some examples, the wheel chocks 104 may be formed to include a slip-resistant structure disposed on a bottom surface thereof The slip-resistant structure may be formed by disposing a slip-resistant material or surface on the bottom surface of the wheel chocks 104. Such a slip-resistant material or surface may include a rubber surface and/or surface texture adapted to reduce or eliminate slipping of the wheel chocks 104 when positioned on the ground.

At step 506, the at least one tongue block attachment structure 302 of each wheel chock 104 can be coupled to a respective wheel chock attachment structure 202 of the tongue block 102. The actual means of coupling the two attachment structures 202, 302 together may depend on the form of the attachment structures 202, 302. By way of example and not limitation, each tongue block attachment structure 302 may be coupled with a respective wheel chock attachment structure 202 by screwing threads together, snapping, hook and loop, magnets, etc.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A tongue block assembly, comprising:
a tongue block comprising a plurality of wheel chock attachment structures; and
a plurality of wheel chocks, each wheel chock comprising at least one tongue block attachment structure, wherein each tongue block attachment structure is coupled with a wheel chock attachment structure of the tongue block.

2. The tongue block assembly of claim 1, wherein the tongue block further comprises at least one depression in a surface thereof, the at least one depression selected from a group of depression comprising:
an arcuate depression;
a circular depression; and
rectangular or square depression.

3. The tongue block assembly of claim 2, wherein the tongue block further comprises:
a slip-resistant structure on a surface opposite the surface in which the at least one depression is located.

4. The tongue block assembly of claim 1, wherein each wheel chock further comprises:
a slip-resistant structure on a bottom surface.

5. The tongue block assembly of claim 1, wherein:
the plurality of wheel chock attachment structures of the tongue block each comprises an outwardly extending protrusion; and
the at least one tongue block attachment structure of each wheel chock comprises a cavity adapted to receive a wheel chock attachment structure therein.

6. The tongue block assembly of claim 1, wherein:
the plurality of wheel chock attachment structures of the tongue block each comprises at least one aperture in a surface of the tongue block; and
the at least one tongue block attachment structure of each wheel chock comprises a protrusion adapted to be received into a wheel chock attachment structure.

7. The tongue block assembly of claim 1, wherein at least some of the plurality of wheel chock attachment structures are configured as a structure selected from a group of wheel chock attachment structures comprising an outwardly extending protrusion, a cavity, and a fastener.

8. The tongue block assembly of claim 1, wherein each tongue block attachment structure of each wheel chock is configured to couple to the plurality of wheel chock attachment structures of the tongue block, and selected from a group of wheel chock attachment structures comprising an outwardly extending protrusion, a cavity, and a fastener.

9. A method of making a tongue block assembly, comprising:
forming a tongue block comprising a plurality of wheel chock attachment structures; and
forming a plurality of wheel chocks, wherein each wheel chock comprises at least one tongue block attachment structure; and
coupling the at least one tongue block attachment structure of each wheel chock to a respective wheel chock attachment structure of the tongue block.

10. The method of claim 9, wherein forming the tongue block comprising the plurality of wheel chock attachment structures comprises:
forming the plurality of wheel chock attachment structures integral to the tongue block.

11. The method of claim 9, wherein forming the tongue block comprising the plurality of wheel chock attachment structures comprises:
forming the plurality of wheel chock attachment structures; and
coupling the plurality of wheel chock attachment structures to the tongue block.

12. The method of claim 9, wherein forming the tongue block comprises:
forming at least one depression in a surface of the tongue block.

13. The method of claim 12, wherein forming the at least one depression in the surface of the tongue block comprises:
forming the at least one depression selected from a group of depression comprising an arcuate depression, a circular depression, a rectangular depression, and a square depression.

14. The method of claim 9, wherein forming the tongue block comprises:
disposing a slip-resistant structure on a surface of the tongue block.

15. The method of claim 9, wherein forming the plurality of wheel chocks, wherein each wheel chock comprises at least one tongue block attachment structure comprises:
forming the plurality of tongue block attachment structures integral to a respective wheel chock.

16. The method of claim 9, wherein forming the plurality of wheel chocks, wherein each wheel chock comprises at least one tongue block attachment structure comprises:
forming the plurality of tongue block attachment structures; and
coupling the one or more tongue block attachment structures to a respective wheel chock.

17. A method of using a tongue block assembly, comprising:
decoupling at least one wheel chock from a tongue block;
positioning the tongue block for receiving at least a portion of a trailer tongue; and
positioning the at least one wheel chock to be adjacent to a trailer wheel.

18. The method of claim 17, wherein positioning the tongue block for receiving at least a portion of a trailer tongue comprises:
positioning the tongue block to receive a wheel associated with a trailer tongue within a depression of the tongue block.

19. The method of claim 17, wherein positioning the tongue block for receiving at least a portion of a trailer tongue comprises:
positioning the tongue block to receive a post associated with a trailer tongue within a depression of the tongue block.

20. The method of claim 17, wherein positioning the tongue block for receiving at least a portion of a trailer tongue comprises:
positioning the tongue block to receive a foot associated with a trailer tongue within a depression of the tongue block.
